(19) United States
(12) Patent Application Publication
(10) Pub. No.: US 2025/0021308 A1
(43) Pub. Date: Jan. 16, 2025

(54) Computer Architecture with Value-Level Parallelism

(71) Applicant: Wisconsin Alumni Research Foundation, Madison, WI (US)

(72) Inventors: Joshua San Miguel, Madison, WI (US); Di Wu, Madison, WI (US); Zhewen Pan, Madison, WI (US)

(21) Appl. No.: 18/221,127

(22) Filed: Jul. 12, 2023

(51) Int. Cl. G06F 7/76; G06F 7/50; G06F 7/523; G06F 7/544

(52) U.S. Cl. CPC G06F 7/76; G06F 7/50; G06F 7/523; G06F 7/5443

(57) ABSTRACT

A computer architecture for computing products and sums of products applies one multiplicand to an accumulator which produces a successive set of product values which may be captured by a capture signal delayed in time according to the second operand. Multiple capture signals from different multipliers can simultaneously make use of the accumulated value allowing value reuse, speeding the calculation of vector and matrix calculations having many identical operands.

### STATEMENT REGARDING FEDERALLY SPONSORED RESEARCH OR DEVELOPMENT

This invention was made with government support under CNS2045985 awarded by the National Science Foundation. The government has certain rights in the invention.

### CROSS REFERENCE TO RELATED APPLICATION

[symbol]

### BACKGROUND OF THE INVENTION

The present invention relates to computer architectures, for example, useful in machine learning applications and, in particular, to an architecture which reduces the burden of computing products between numbers by value reuse.

Computer applications, such as machine learning may require the processing of data sets of quintillions of bytes per day. One obstacle to such processing is in the movement of data between memory and computation units. This has been addressed by data reuse and caching and by reducing the precision (size) of the data. Multiple low-precision data formats, e.g., INT8 (8-bit integers) and BF16 (16-bit floating point), have been developed that can be used with deep neural networks with negligible loss of accuracy. Recently more aggressive data formats, e.g., INT4, have been proposed.

### SUMMARY OF THE INVENTION

The present inventor has recognized that reductions in data precision have created increased opportunity for data value reuse. Data value reuse considers reuse of the results of calculations, and thus can be distinguished from systems which improve the data before calculation using that data.

As an example of the value reuse opportunity available with low-precision numbers, consider an input vector having a 1024 INT4 value multiplied by a scalar INT4 value. Conventional hardware would require 1024 multiplications; however, the final vector of products of two INT4 values has at most 16 unique values suggesting that reuse of these product values could greatly reduce the number of necessary multiplications. Building on this insight, the present invention provides an architecture that allows computed products to be reused in different calculations, dramatically reducing computational burden.

More specifically, in one embodiment, the invention provides a computer architecture having a set of first inputs for receiving multiplicands and a set of temporal converters receiving the first inputs to produce corresponding capture signals at corresponding time delays from corresponding start times. These capture signals have a time delay proportional to the values of the first inputs. The processor also receives a set of second multiplier inputs and provides set of accumulators receiving corresponding second inputs to produce corresponding accumulated values proportional to values of the corresponding second inputs and time delays from corresponding start times. A selection circuitry captures, for each given first input, a corresponding accumulated value for a given second input at the time of the capture signal of the given first input to output a product of each given first input and each given second input.

It is thus a feature of at least one embodiment of the invention to allow a set of different input values to make use of shared, accumulated values (representing product values) offering a simple method for efficiently reusing the calculations necessary for determining a product.

The selection circuitry may operate to capture multiple accumulated values for each capture signal.

It is thus a feature of at least one embodiment of the invention to provide value reuse for multipliers.

Similarly, the selection circuitry may operate to capture a given accumulated value for multiple capture signals.

It is thus a feature of at least one embodiment of the invention to provide value reuse used for multiplicands.

The architecture may further include a summing circuit for summing together product outputs of sets of first inputs and second inputs to produce a summed output.

It is thus a feature at least one embodiment of the invention to produce an architecture that can efficiently compute outer products.

The architecture may include a sequencer for changing the set of first inputs and second inputs to compute multiple outer products and thus provide a matrix multiplication.

It is thus a feature at least one embodiment of the invention to provide an efficient architecture for matrix multiplication useful in machine learning and other applications.

The first set of input values and second set of input values have a precision of no greater than 16.

It is thus a feature of at least one embodiment of the invention to provide an architecture well adapted for low-precision data where there is an increased likelihood of value reuse.

The set of temporal converters may produce capture signals at discrete time increments, and the accumulators may increment the accumulated values by the corresponding value of the second input at each discrete time increment.

It is thus a feature of at least one embodiment of the invention to expose the stages of successive addition, that can be used for multiplication, in discrete time intervals, exposing the values at the stages to increase opportunity for calculation reuse.

The accumulators may operate to successively add a given second input to an accumulated value of the given second inputs at each time increment.

It is thus a feature of at least one embodiment of the invention to implement multiplication with a set of simple and fast summation or accumulation operations.

The selection circuit may provide a set of processing elements each receiving a same accumulated value along a logical column and each receiving a same capture signal along the logical row by passing the accumulated values and capture signals in pipeline fashion through the processing elements.

It is thus a feature of at least one embodiment of the invention to provide a pipelined architecture simplifying the interconnection of the various processing elements and data transfer between processing elements and providing for effective parallel computation.

The set of first inputs and set of second inputs may each represent one of machine learning weights and machine learning input values implementing a neural network.

It is thus a feature of at least one embodiment of the invention to provide architecture well suited to deep neural networks acceptably using low-precision numbers.

The weights may represent weights of a machine learning model.

It is thus a feature of at least one embodiment of the invention to provide an architecture that advantageously can operate with value-and bit-dense data sets.

These particular objects and advantages may apply to only some embodiments falling within the claims and thus do not define the scope of the invention.

### BRIEF DESCRIPTION OF THE DRAWINGS

FIG. 1 is a block diagram of the principal components of one embodiment of the present invention including a sequencer for obtaining values from a main memory for processing, a set of temporal converters, and a set of accumulators for receiving those values and providing them to a set of processing elements, the latter outputting product values to a summing circuit to determine outer products to be returned to the sequencer for storage and memory;

FIG. 2 is a simplified example of the operation of the temporal converters and a single accumulator for producing and sharing partial product values;

FIG. 3 is a simplified block diagram of the processing elements configured in a pipeline having processing elements sharing accumulator values along columns and capture signals along rows; and

FIG. 4 is a depiction of an example matrix multiplication that may be implemented by the present invention and used for an example computation of an outer product; and

FIGS. 5-10 are depictions of the processing elements of FIG. 3 showing an example processing sequence for the multiplication of FIG. 4.

### DETAILED DESCRIPTION OF THE PREFERRED EMBODIMENT

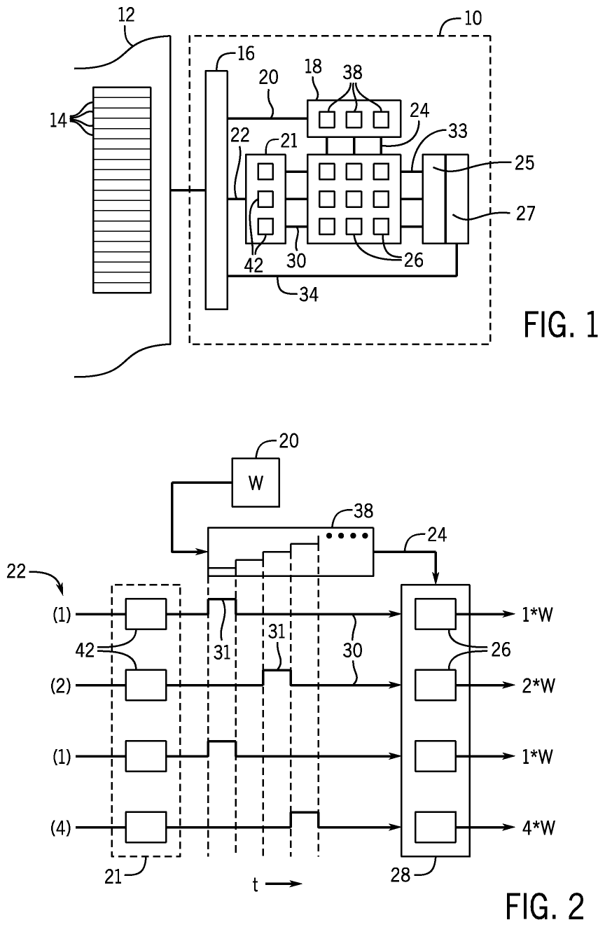

Referring now to FIG. 1, a computer architecture 10 of the present invention may communicate with a computer memory 12 for holding stored values 14 to be processed. The computer memory may provide, for example, a standard cache-structured memory including a mixture of static random access memory (SRAM), dynamic random access memory (DRAM), solid-state or mechanical disk drives, and other known memory types suitable for this purpose.

The stored values 14 may, in one non-limiting example, represent operands of a matrix multiplication, for example, as may describe input values and weights for a machine learning system implementing a neural network. The present invention is particularly well suited for machine learning models with high-value density and high-bit density, that is, matrices which are not sparse and which therefore are not well-adapted to other acceleration techniques. In one important example, the machine learning model may be a language model trained on sequences of words such as so-called large language models (LLM).

Machine learning applications can be efficiently executed by the present invention because of a high likelihood that product calculations (values) can be shared. This occurs when there are many input variables and variables of low precision, for example, having less than 16 bits, less than 8 bits, or even 4 bits or less. In that regard, the stored values 14 may be reduced-precision integer or floating-point values such as INT16, INT8, INT4, FP8, or the like, shown to be successful in many machine learning models. Generally, the present invention will process the mantissa of floating-point values which must be multiplied with the exponents handled separately by addition.

Referring still to FIG. 1, in overview, the computer architecture 10 provides a sequencer 16 coordinating the movement of stored values 14 into the architecture 10 from the memory 12 for processing and returning the results to the memory 12. In particular, the sequencer 16 provides a set of multiplicands 20 to an accumulator array 18 holding a set of accumulators 38 associated with each multiplicand 20. Generally, the number of accumulators 38 will match the precision (number of bits) of a set of multipliers 22 (for floating-point, only the mantissa bits) or, in some cases, the number of bits minus one when multiplication by zero is excluded.

The sequencer 16 provides the set of multipliers 22 to a temporal converter array 21 holding a set of temporal converters 42 associated with each multiplier 22. The number of temporal converters 42 may be arbitrarily large.

Corresponding pairs of multiplicands 20 and multipliers 22, for example, may represent values of different vectors, for example, providing for a computation of an outer product in a matrix multiplication.

During operation of the computer architecture 10, the accumulator array 18 converts the set of multiplicands 20 to accumulated values 24 that steadily increase over time. These accumulated values 24 are provided in parallel to a column of processing elements 26 in a processing element array 28. The temporal converters 42 convert the set of multipliers 22 into capture signals 31 that operate to cause the processing elements 26 to capture a corresponding accumulated value 24 at a particular time designated by the capture signal 31. This captured accumulated value 24 represents a product output 33 (being a multiplication between a multiplicand 20 and a multiplier 22) as will be discussed in more detail below. The product outputs 31 are then received by a summing circuit 27 adding the product outputs 31 together to generate product matrix values 34. The product matrix values 34 are returned to the sequencer 16 for storage in the memory 12 (for example, as an element in a product matrix). After completion of operations on the current multiplicands 20 and multipliers 22, the sequencer 16 may select a new set of multiplicands 20 and multipliers 22 for additional processing either of the same matrix multiplication or a new matrix multiplication as will be generally understood in the art.

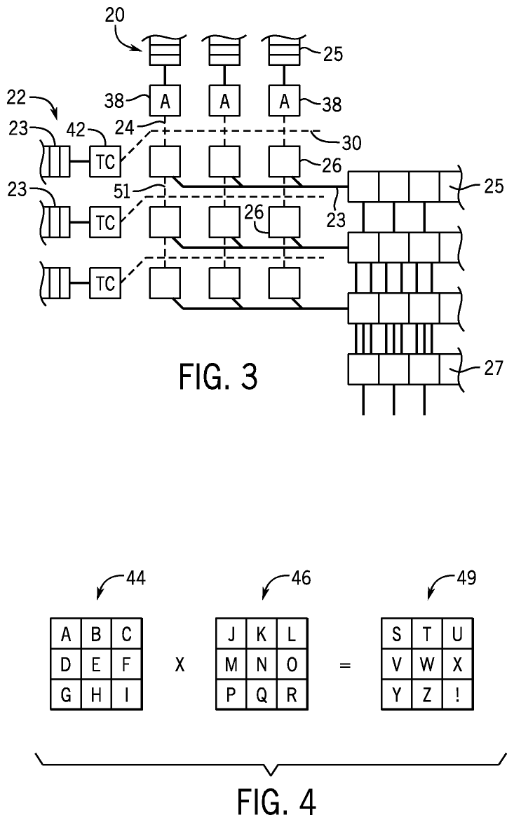

Referring now to FIG. 2, for the purpose of multiplying multiplicands 20 by multipliers 22, the multiplicands 20 will be received by the accumulators 38 to be independently accumulated, a process of adding the multiplicands 20 to themselves on a regular time period established by a clock to produce a steadily increasing running total. This simplified example will describe this process with respect to multipliers 22 having a precision of 3 bits and thus possible values of 0-7. Such a multiplicand 20 having value w received by an accumulator 38 will then output an accumulated value 24 starting at 0 and proceeding through w, 2w, 3w . . . 7w. The accumulated value 24 will be provided in common to a set of processing elements 26 of a column operating as registers that may be triggered to capture the accumulated value 24 by a capture signal 31 from a temporal converter 42 and triggering the processing elements 26 at different times.

More specifically, the temporal converters 42 produce a capture signal 31 having a time delay proportional to the value of the multiplier 22 and synchronized to the operation of the accumulators 38 producing the accumulated value 24. Thus, in this example, an operand having a value of 1 produces a capture signal 31 (represented as a pulse) coincident with the value of w being output as the accumulated value 24 from the accumulator 38. The confluence of these signals causes the accumulated value 24 to be captured by the corresponding processing element 26 as w equal to the product of 1 and w. Similarly, the multiplier 22 having a value of 2 produces a capture signal 31 coincident with the value of 2w being output from the accumulator 38 causing 2w (the product of 2 and w) to be captured by the processing element 26. Thus, multiplication is implemented simply by properly timing the capture of the accumulated signal. Importantly this mechanism allows all multipliers 22 having the same value (for example, other operands having values of 1 or 2) to also use the same accumulated value 24, allowing the calculation of the accumulated value 24 to be reused eliminating redundant calculation of this product.

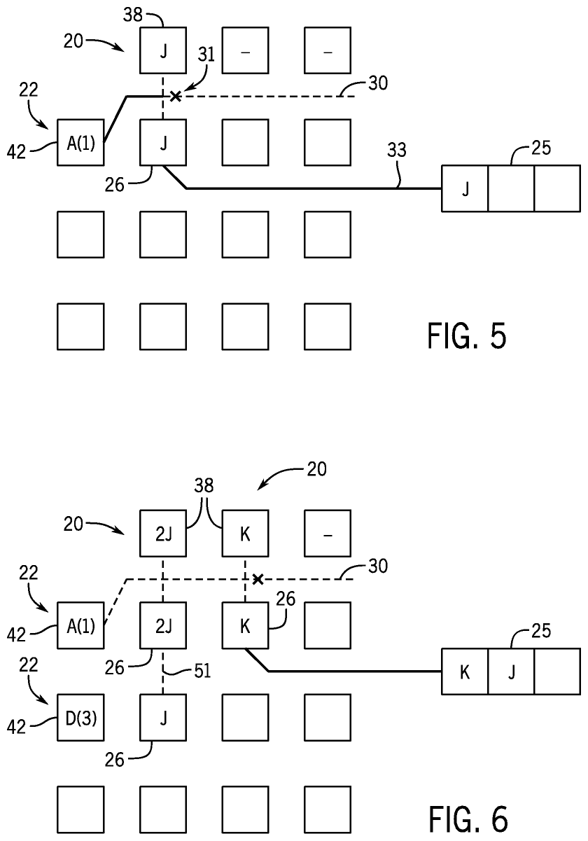

Referring now to FIG. 3, the principles described with respect to FIG. 2 above may be implemented in a pipeline system in which processing elements 26 are arranged in rows and columns. Each of the columns share a common accumulated value 24 that will pass downward through the processing elements 26 of that column on a pipeline 51 (depicted by a dotted line) moving by one processing element 26 for each clock cycle. Each of the rows shares a common operand “capture signal” that will pass rightward through the processing elements 26 of that row on a pipeline 30 again moving by one processing element 26 for each clock cycle. More generally, each column shares a common accumulator 38 and each row shares a common temporal converter 42.

The processing elements 26 of each row communicate with a FIFO register 25 dedicated to that row to receive a captured value from the accumulator 38 to the FIFO register 25 when activated by a capture signal 31 passing along pipeline 30. The FIFO register 25 for each row communicate with a sorter/summer 27 which will collect various values from the FIFO buffers 25 and sum them together to produce the elements of the matrix product.

To assist in this pipelining process, the multiplier values 22 will be applied in staggered fashion from registers 23 to the temporal converters 42 starting at the top row and proceeding to the bottom row, the arrival of each multiplier 22 defining a start time for the calculations associated with that multiplier 22. Similarly, the operation of the accumulators 38 will be staggered with the accumulators 38 receiving multiplicands 20 from registers 25 so that accumulation begins earlier at the leftmost accumulator 38 and processing rightwardly with each clock transition. This pipelining assists in managing interconnections between the elements and effectively implements parallel calculations; however, the invention contemplates that a non-pipeline version could be produced.

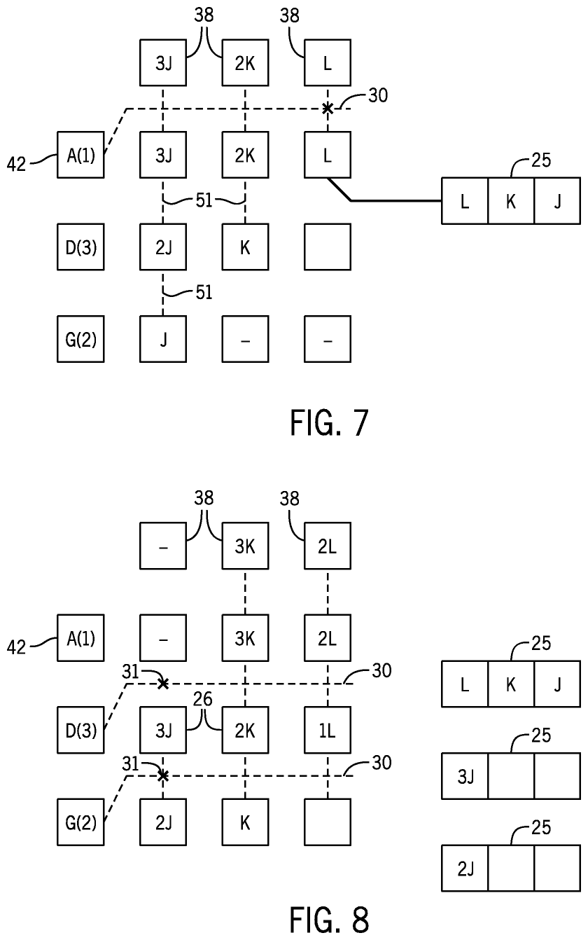

Referring now to FIG. 4, in a simple example, the operation of the computer architecture 10 of FIG. 3 may provide a calculation of products used in a matrix multiplication of a 3×3 matrix 44 with a 3×3 matrix 46 to produce the resulting 3×3 matrix 49. Such a matrix multiplication represents a class of calculations useful, for example, for processing a neural net input layer signal by a set of neural net weights.

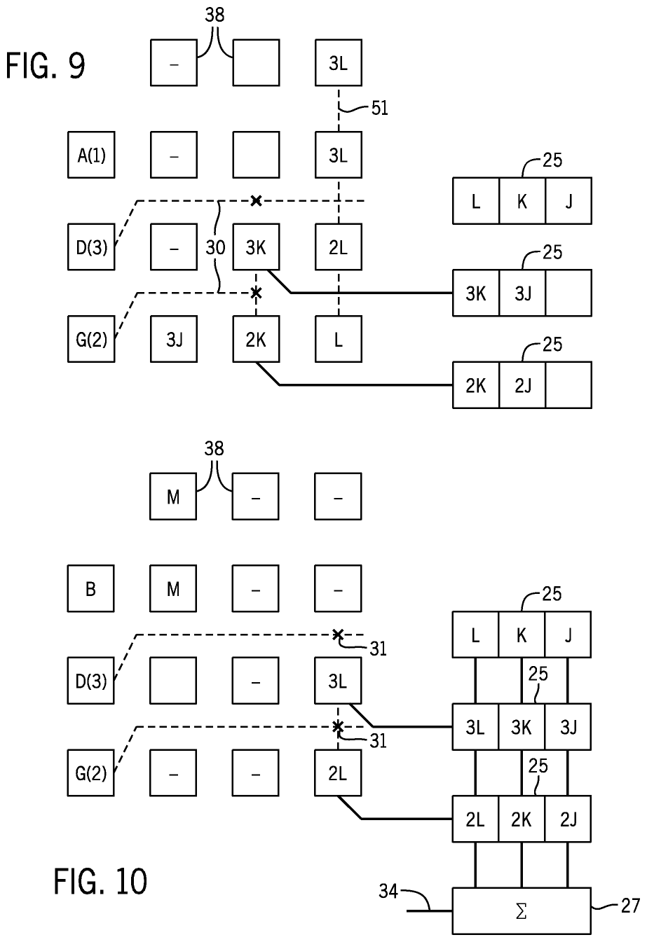

At cycle 1, illustrated by FIG. 5, a first multiplier 22 of A(1) (where A indicates its place within the matrix 44 of FIG. 4 and 1 indicates its value) is received at the temporal converter 42 of the first row at the same clock transition, a first multiplicand 20 of J (where J indicate its place within the matrix 46 of FIG. 4) is received at the leftmost accumulator 38. Note that the zero-ranked rows and columns have been omitted from this figure for simplicity representing the trivial case of multiplication by zero which may, for example, be trapped prior to processing to reduce circuit complexity or implimented by starting the accumulation at zero for a first cycle.

Upon receiving the multiplier 22, the temporal converter 42 introduces a capture signal 31, for example a binary bit 1, into the pipeline 30 at the processing element 26 for the first column and first row. The timing of the introduction of this capture signal 31 is determined by the value of the multiplier 22, in this case: 1. This capture signal 31 will proceed along the row through different columns in pipeline fashion according to a synchronizing clock signal.

Similarly, the accumulator 38 introduces the first multiplicand 20 into the pipeline 51 to the processing element 26 at the first column and first row. This multiplicand 20 will proceed along the column through different rows in pipeline fashion again according to the synchronizing clock signal.

The coincidence of the capture signal 31 and the multiplicand 20 of J at this first processing element 26 causes a capture of this multiplicand 20 and its transmission to the FIFO register 25 representing the product of (1*J).

At cycle 2, illustrated by FIG. 6, a second multiplicand 20 of K is introduced in the second column and proceeds in the pipeline 51 to the first processing element 26 of that column. At this time, the capture signal 31 has moved by pipeline 30 to the second column, a coincidence which causes a capture of the value K by the corresponding processing element 26 which is forwarded to the FIFO register 25 and representing the product (1*K). Also at this time, the accumulator 38 of the first column adds (accumulates) the multiplicand 20 of J to itself to produce a value of 2J which is input to the pipeline 51 to be provided to the processing element 26 of the first row and column. The previous value of J moves down one row in pipeline fashion. A new multiplier 22 D(3) is also introduced at the second row, but no capture signal 31 is produced yet because this is the first clock cycle of its introduction and its value of (3) will delay the capture signal 31 until the third clock cycle.

At cycle 3, illustrated at FIG. 7, the capture signal 31 of the first row reaches the third column where a multiplicand 20 of L is now provided. This causes a capture of this multiplicand value which is provided to the FIFO register 25. A new multiplier G(2) is introduced at the third row but again produces no capture signal 31 at this time. The accumulator 38 of the first row now outputs a value of 3J, by again adding J to its previous value, and the earlier output values march downwardly in pipeline fashion. Similarly, the accumulator 38 of the second row, now outputs a value of 2K.

At cycle 4, as illustrated by FIG. 8, three cycles have passed since the introduction of the multiplier D(3) and so this temporal converter 42 of the second row releases its capture signal 31 into the pipeline 30. At this time, it achieves coincidence with the accumulated multiplicand of 3J causing this value of 3J to be sent to the corresponding FIFO register 25 as a product 3*J. The multiplier 22 of G(2) also releases a capture signal 31 at this time aligning with the accumulated multiplicand of 2J causing this value of 2J to be captured by the corresponding FIFO register 25 as the effective product of the multiplicand 20 and multiplier 22.

At cycle 5, as illustrated by FIG. 9 the capture signal 31 of the second row now aligns with the second column to cause capture of the value 3K and the capture signal 31 of the third row aligns with a processing element holding 2K to capture this value also forwarded to a FIFO register 25.

At cycle 6, as illustrated by FIG. 10, the capture signals 31 of the second and third row arrive at the third column to capture, respectively, the values of 3L and 2L.

At this point, the outer product of the first column of the matrix 44 with the first row of the matrix 46 (shown in FIG. 4) needed for the matrix multiplication has been fully computed. This process may be repeated for the second column+row and third column+row. The summer 27 may then sort the calculated outer products to produce the elements of the product matrix 49 with a set of addition operations.

As described above, the multipliers 22 from a next column of matrix 44 may be processed by introducing the temporal converters 42 in staggered fashion. It will be appreciated that by adding additional rows to the depicted architecture these multipliers 22 may in fact make use of the previous accumulated values for even additional reuse.

Certain terminology is used herein for purposes of reference only, and thus is not intended to be limiting. For example, terms logical columns and logical rose does not require a particular orientation such as vertical or horizontal or that elements field arranged in a line but simply that they operate in a logically equivalent way to such a configuration. Such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

1. A computer processor architecture comprising:
a set of first inputs for receiving multiplicands;
a set of temporal converters receiving the first inputs to produce corresponding capture signals at corresponding time delays from corresponding start times and proportional to values of the corresponding first inputs;
a set of second inputs for receiving multipliers;
a set of accumulators receiving corresponding second inputs to produce corresponding accumulated values proportional to values of the corresponding second inputs and time delays from corresponding start times;
selection circuitry capturing for each given first input a corresponding accumulated value for a given second input at the time of the capture signal of the given first input to output a product of each given first input and each given second input; and
wherein the selection circuit provides a set of processing elements each receiving a same accumulated value along a logical column and each receiving a same capture signal along the logical row by passing the accumulated values and capture signals in pipeline fashion through the processing elements.

2. The computer processor architecture of claim 1 further including a sequencer providing a set of multiplicands and a set of multipliers for an outer product calculation sequentially to rows of the temporal converters and sequentially to columns of the accumulators, in time with each clock cycle.

3. The computer processor architecture of claim 1 wherein the selection circuitry operates capture a given accumulated value for multiple capture signals.

4. The computer processor architecture of claim 1 further including a summing circuit for summing together product outputs for each capture signal to produce a summed output.

5. The computer processor architecture of claim 3 further including a sequencer for changing the set of first inputs and second inputs to provide a matrix multiplication formed of outer products represented by the summed output.

6. The computer processor architecture of claim 1 wherein the first set of input values and second set of input values have a precision of no greater than 16.

7. The computer processor architecture of claim 1 wherein the set of temporal converters produces capture signals at discrete time increments and wherein the accumulators increment the accumulated values by the corresponding value of the second input at each discrete time increment.

8. The computer processor architecture of claim 7 wherein the accumulators operate to successively add each given second input to an accumulated value of previously added given second inputs at each time increment.

9. (canceled)

10. The computer processor architecture of claim 1 wherein the set of first inputs and set of second inputs each represent one of machine learning weights and machine learning input values implementing a neural network.

11. The computer processor architecture of claim 10 wherein the machine learning weights represent weights of a machine learning language model.

12. A method of calculation on a computer processor architecture having:
a set of first inputs for receiving multiplicands;
a set of temporal converters receiving the first inputs to produce corresponding capture signals at corresponding time delays from corresponding start times and proportional to values of the corresponding first inputs;
a set of second inputs for receiving multipliers;
a set of accumulators receiving corresponding second inputs to produce corresponding accumulated values proportional to values of the corresponding second inputs and time delays from corresponding start times; and
selection circuitry capturing for each given first input a corresponding accumulated value for a given second input at the time of the capture signal of the given first input to output a product of each given first input and each given second input; the method including:
(a) applying multiplicands and multipliers to the first inputs and second inputs;
(b) capturing accumulated values of the second inputs based on the time delays of the first inputs to provide products of the first and second inputs; and
wherein the selection circuit provides a set of processing elements each receiving a same accumulated value along a logical column and each receiving a same capture signal along the logical row by passing the accumulated values and capture signals in pipeline fashion through the processing elements.

13. The method of claim 12 further including a sequencer providing a set of multiplicands and a set of multipliers for an outer product calculation sequentially to rows of the temporal converters and sequentially to columns of the accumulators in time with each clock cycle.

14. The method of claim 12 wherein the selection circuitry operates capture a given accumulated value for multiple capture signals.

15. The method of claim 12 further including a summing together of product outputs for each capture signal to produce a summed output.

16. The method of claim 15 further including changing the set of first inputs and second inputs to provide a matrix multiplication formed of outer products represented by the summed output.

17. The method of claim 12 wherein the first set of input values and second set of input values have a precision of no greater than 16.

18. The method of claim 12 wherein the set of temporal converters produces capture signals at discrete time increments and wherein the accumulators increment the accumulated values by the corresponding value of the second input at each discrete time increment.

19. The method of claim 18 wherein the accumulators operate to successively add each given second input to an accumulated value of previously added given second inputs at each time increment.

20. (canceled)

21. The method of claim 12 wherein the set of first inputs and set of second inputs each represent one of machine learning weights and machine learning input values implementing a neural network.

22. The method of claim 21 wherein the machine learning weights represent weights of a machine learning language model.

24. The computer processor architecture of claim 1 wherein the set of accumulators produce successive corresponding cumulative values synchronized to a clock signal and wherein the accumulated values pass in pipeline fashion along the logical column by one processing element in each clock cycle.

25. The computer processor architecture of claim 1 including first-in, first-out registers associated with each logical row for receiving products from the selection circuit.

26. The computer processor architecture of claim 1 wherein the capture signal is a count value passing in pipeline fashion along a row and a time of the capture signal is determined by the count value and the number of processing elements traversed by the count value in pipeline fashion.
